(19) United States
(12) Patent Application Publication
(10) Pub. No.: US 2025/0192162 A1
(43) Pub. Date: Jun. 12, 2025

(54) POSITIVE ELECTRODE ACTIVE MATERIAL FOR LITHIUM SECONDARY BATTERY, PREPARATION METHOD THEREFOR, AND POSITIVE ELECTRODE FOR LITHIUM SECONDARY BATTERY CONTAINING SAME

(71) Applicants: CORENERGY SOLUTION CO., LTD., Suwon-si (KR); RESEARCH & BUSINESS FOUNDATION SUNGKYUNKWAN UNIVERSITY, Suwon-si (KR)

(72) Inventors: Young-Jun KIM, Seongnam-si (KR); Jung-Hun LEE, Seoul (KR); Jin-Kyo KOO, Suwon-si (KR); Jeong-Min SHIN, Uiwang-si (KR)

(21) Appl. No.: 19/055,686

(22) Filed: Feb. 18, 2025

Related U.S. Application Data
(63) Continuation of application No. PCT/KR2023/012289, filed on Aug. 18, 2023.

(30) Foreign Application Priority Data
Aug. 18, 2022 (KR) 10-2022-0103635
Aug. 18, 2023 (KR) 10-2023-0108401

(51) Int. Cl. H01M 4/36; H01M 4/02; H01M 4/04; H01M 4/131; H01M 4/1391; H01M 4/525; H01M 4/62

(52) U.S. Cl. CPC H01M 4/366; H01M 4/0435; H01M 4/131; H01M 4/1391; H01M 4/525; H01M 4/623; H01M 4/625; H01M 2004/021; H01M 2004/028

(57) ABSTRACT

The present invention relates to a positive electrode active material for a lithium secondary battery, comprising a particle-shaped lithium transition metal oxide and a surface layer having a thickness of 10 nm to 100 nm provided on the surface of the lithium-transition metal oxide, wherein: the surface layer comprises carbon nanotubes provided in a three-dimensional reticular form and an organic compound physically attached to the carbon nanotubes; the carbon nanotubes are connected in a reticular form on the surface of the lithium transition metal oxide, forming a mutual electrical network; at least a portion of the carbon nanotubes are spaced apart to provide space in the thickness direction of the surface layer; and 100 parts by weight of the carbon nanotubes contains 30 to 90 parts by weight of the organic compound.

### TECHNICAL FIELD

The present invention relates to a positive electrode active material, a method for preparing the same, and a positive electrode for a lithium secondary battery including the same, and more specifically, to a positive electrode active material having excellent electrochemical characteristics by applying a novel method, a method for preparing the same, and a positive electrode for a lithium secondary battery including the same.

### BACKGROUND ART

As the demand for carbon emission reduction technology and ecofriendly energy production technology to mitigate global warming increases, technology development and production for electrochemical 1 energy storage devices are becoming a global issue. In particular, batteries are being developed with a focus on maximizing energy density, life span, and environmental friendliness as a core technology for energy storage devices.

Lithium ion batteries (LIB) are widely used as power sources for portable electronic devices, electric vehicles, and ESSs. The lithium ion battery market is increasingly demanding higher performance and lower production costs. The performance and production cost of the lithium ion battery are highly dependent on a series of process steps for preparing the lithium ion battery and production technology including the materials, electrodes, cells, and modules/packs consisting of the lithium ion battery.

As an example, studies have been conducted to increase capacity by increasing the content of nickel and to reduce cost by lowering the content of cobalt while using a positive electrode active material used in the lithium ion battery as a nickel-rich (Ni-rich)-based positive electrode material.

On the other hand, such a nickel-rich positive electrode material has limitations in structural and electrochemical stability, which is further aggravated due to the high nickel composition.

Accordingly, various studies have been conducted to improve performance while increasing capacity at a lower cost in the positive electrode active material of the lithium ion battery.
Prior Art Patent: KR10-1196962 (Oct. 26, 2012)

### DISCLOSURE

### Technical Problem

An objective of the present invention is to provide a positive electrode active material for a lithium secondary battery, which prevents an unnecessary interfacial reaction with an electrolyte and has an excellent electrical conductivity and thermal stability by providing the positive electrode active material for a lithium secondary battery having a surface layer formed thereon, a method for preparing the same, and a positive electrode for a lithium secondary battery including the same.

In addition, another objective of the present invention is to provide a positive electrode active material for a lithium secondary battery, which is easily mass-produced and has improved electrode density and cycle characteristics by physicochemically providing carbon nanotubes on a surface of a lithium transition metal oxide by a novel method, a method for preparing the same, and a positive electrode for a lithium secondary battery including the same.

In addition, still another objective of the present invention is to provide a lithium secondary battery including the positive electrode active material and the positive electrode.

### Technical Solution

According to one aspect of the present invention, embodiments of the present invention includes a positive electrode active material for a lithium secondary battery, the positive electrode active material including: a particle-shaped lithium transition metal oxide; and a surface layer provided with a thickness of 10 nm to 100 nm on a surface of the lithium transition metal oxide, in which the surface layer includes carbon nanotubes having a three-dimensional reticular form and an organic compound physically attached to the carbon nanotubes, the carbon nanotubes are connected in a reticular form on the surface of the lithium transition metal oxide to form a mutual electrical network, and at least a portion of the carbon nanotubes are spaced apart to provide a space in a thickness direction of the surface layer, and the organic compound is included in an amount of 30 parts by weight to 90 parts by weight based on 100 parts by weight of the carbon nanotubes.

According to one embodiment, the carbon nanotubes may be formed in a bundle form by partially concentrating 1 to 10 single-walled carbon nanotubes or multi-walled carbon nanotubes, and the bundle form may have a diameter of 2 nm to 35 nm and a length of 10 μm to 10 mm, and as components of the carbon nanotubes, a content of oxygen atoms with respect to carbon atoms may be 0.01 mol % to 10 mol %.

According to one embodiment, a ratio (ID/IG) of a maximum peak intensity of a D band at 1340 nm to 1360 nm with respect to a maximum peak intensity of a G band at 1575 nm to 1600 nm, which is obtained by a Raman spectrum using a laser having a wavelength of 514.5 nm, may be 0.5 to 1.5.

According to one embodiment, a ratio of a surface area (S1) of the lithium transition metal oxide with respect to a surface area (S2) of the positive electrode active material may satisfy Expression 1:

$$0.02 \leq S 1 / S 2. \qquad ( Expression 1 )$$

According to one embodiment, the organic compound may include at least one functional group of an epoxy group, a carboxyl group, an amino group, an ether group, an amine group, an imide group, a nitrile group, an acrylic group, a double bond, and a triple bond.

According to one embodiment, the lithium transition metal oxide may include secondary particles composed of a group of a plurality of primary particles, the secondary particles may be represented by Chemical Formula 1 below, and the secondary particles may have an average particle diameter (D50) of 2 μm to 30 μm and a BET specific surface area of 0.1 m²/g to 1.0 m²/g:

LiₐNi_{1-x-y}CoₓM1_{y}O₂ [Chemical Formula 1]
(wherein M1 is any one or two or more elements selected from the group consisting of Mn, Al, Zr, Ti, Mg, Ta, No, W, Mo, and Cr, and satisfies 1.0≤a≤1.5, 0≤x≤0.5, 0≤y≤0.5, and 0≤x+y≤0.5).

According to one embodiment, the lithium transition metal oxide may include single particles and a plurality of fine particles attached to a surface of the single particles, the single particles may be represented by Chemical Formula 1 below, and the single particles may have an average particle diameter (D50) of 2 μm to 10 μm and a BET specific surface area of 0.5 m²/g to 2.5 m²/g, and the fine particles may have an average particle diameter (D50) of 0.01 to 0.1 times the average particle diameter of the single particles:

LiₐNi_{1-x-y}CoₓM1_{y}O₂ [Chemical Formula 1]
(wherein M1 is any one or two or more elements selected from the group consisting of Mn, Al, Zr, Ti, Mg, Ta, Nb, W, Mo, and Cr, and satisfies 1.0≤a≤1.5, 0≤x≤0.5, 0≤y≤0.5, and 0≤x+y≤0.5).

According to one embodiment, the positive electrode active material may have a powder conductivity of 0.01 S/cm to 1 S/cm under a pressure of 4 kN/cm².

According to one embodiment, the lithium transition metal oxide may include 50 mol % or greater of nickel (Ni), a content ratio of the carbon nanotubes with respect to the lithium transition metal oxide may be 0.1 wt % to 1 wt %, and the carbon nanotubes may be in an amount of 30 parts by weight to 80 parts by weight based on total 100 parts by weight of the carbon nanotubes and the organic compounds.

According to one embodiment, the surface layer may be provided by impregnating the lithium transition metal oxide in a CNT ink and physically applying a force thereto.

According to another aspect of the present invention, the embodiment of the present invention includes a method for preparing a positive electrode active material for a lithium secondary battery, the method including: preparing a CNT ink by adding a carbon nanotube raw material and an organic compound to an organic solvent; preparing a dispersion solution by adding a lithium transition metal oxide to the CNT ink; adding an additive and an anti-solvent to the dispersion solution; and drying a mixture thereof in an oven at a temperature of 120° C. to 180° C. for 1 hour to 24 hours. According to one embodiment, the organic solvent may include any one or more of N-methyl-2-pyrrolidone (NMP), polypyrrolidone, isopropanol, petroleum ether, tetrahydrofuran, ethyl acetate, N, N-dimethylacetamide, N, N-dimethylformamide, n-hexane, and halogenated hydrocarbon, the organic compound may include any one or more of polyacrylonitrile (PAN), polyvinyl pyrrolidone (PVP), polyvinyl alcohol (PVA), polyacrylic acid (PAA), and polyamideimide (PAI), the anti-solvent may include any one or more of ultrapure water, methanol, acetone, and ethanol, and the additive may include any one or more of a chloride, a carbonate, a hydroxide, and a nitrate of metal.

According to one embodiment, the preparation of the CNT ink may include ultrasonically mixing for 0.5 hour to 12 hours, the preparation of the dispersion solution may include physically stirring for 0.5 hour to 72 hours, the adding of the additives and the anti-solvent may include physically stirring for 5 minutes to 1 hour at 100 rpm to 5000 rpm after adding the additive and the anti-solvent, and the drying may further include selecting a solid-state material before putting the same in the oven.

According to still another aspect of present invention, the present invention includes a positive electrode for a lithium secondary battery, the positive electrode including: the positive electrode active material of any one of claims 1 to 10; a binder; and a conductive material, in which based on total 100 parts by weight of the positive electrode active material, the binder, and the conductive material, the binder is included in an amount of 0.2 parts by weight to 3 parts by weight and the conductive material is included in an amount of 0 parts by weight to 5 parts by weight.

According to one embodiment, the conductive material may include any one or more of carbon nanotubes, graphene, graphite, carbon black, and carbon fiber, and the binder may include any one or more of polyvinylidene fluoride (PVDF), polytetrafluoroethylene (PTFE), polyacrylic acid (PAA), and polyamideimide (PAI).

According to other aspects of the present invention, the present invention includes a method for preparing a positive electrode for a lithium secondary battery, the method including: preparing a positive electrode mixture raw material by physically mixing the positive electrode active material and a powdered binder at room temperature; preparing the positive electrode mixture raw material into a sheet-shaped preliminary positive electrode layer using a rolling roll; and preparing the positive electrode by attaching the sheet-shaped preliminary positive electrode layer to at least one surface of a current collector and pressing the sheet-shaped preliminary positive electrode layer using a heating roll at a temperature of 20° C. to 350° C., in which the positive electrode is provided by laminating one or more sheet-shaped positive electrode layers and one or more current collectors, and the sheet-shaped positive electrode layer has a loading level of 10 mg/cm² to 50 mg/cm².

According to one embodiment, the preparation of the positive electrode mixture raw material may include stirring and mixing the positive electrode active material and the powdered binder at room temperature, and in the preparation of the sheet-shaped preliminary positive electrode layer, the binder included in the sheet-shaped preliminary positive electrode layer may be dispersed in a fibril form having a fibrous structure.

According to one embodiment, in the preparation of the sheet-shaped preliminary positive electrode layer, the rolling roll may apply a pressure of 5 kgf/cm to 100 kgf/cm at a temperature of 20° C. to 350° C., and in the preparation of the positive electrode, the heating roll may apply a pressure of 5 kgf/cm to 100 kgf/cm at a temperature of 20° C. to 350° C. According to one embodiment, the powdered binder may include any one or more of polyvinylidene fluoride (PVDF), polytetrafluoroethylene (PTFE), polyacrylic acid (PAA), and polyamideimide (PAI), and the powdered binder may be included in an amount of 0.4 parts by weight to 5 parts by weight based on 100 parts by weight of the positive electrode active material.

According to one embodiment, the positive electrode active material may have an average particle diameter (D50) of 2 μm to 30 μm, and the powdered binder may have an average particle diameter (D50) of 2 μm to 800 μm.

According to one embodiment, the thickness of the sheet-shaped positive electrode layer may be 50 μm to 500 μm, the thickness of the sheet-shaped positive electrode layer may be 30 μm to 200 μm, the density of the sheet-shaped positive electrode layer may be 30% to 90% with respect to the density of the sheet-shaped positive electrode layer, and the electrical conductivity of sheet-shaped positive electrode layer may be 0.1 S/cm or greater.

According to one embodiment, the current collector may have a thickness of 3 μm to 500 μm and a tensile strength of 135 N/mm² to 265 N/mm², and the current collector may include any one or more of aluminum, stainless steel, nickel, titanium, and calcined carbon.

### Advantageous Effects

According to the present invention as described above, the positive electrode active material for a lithium secondary battery, the method for preparing the same, and the positive electrode for a lithium secondary battery including the same may have excellent physical properties and may be mass-produced at a low cost.

In addition, according to the present invention, it is possible to provide a positive electrode active material for a lithium secondary battery, a method for preparing the same, and a positive electrode for a lithium secondary battery including the same, in which the positive electrode active material having a surface layer, including carbon nanotubes, formed thereon, may prevent agglomeration between particles, and the surface layer is maintained by an external force applied during a process, thereby improving charge/discharge characteristics and cycle characteristics.

In addition, according to the present invention, the contents of the conductive material and the binder included in the positive electrode active material or the like may be reduced, so that it is possible to effectively reduce production costs.

In addition, according to the present invention, the positive electrode active material induces the formation of an electrical coupling network between materials by the surface layer, and has a high binding force without using a separate solvent, so that it is possible to provide an environment-friendly process.

### DESCRIPTION OF DRAWINGS

FIG. 1 is a view showing a positive electrode active material according to one embodiment of the present invention.

FIG. 2 is a view schematically showing the positive electrode active material of FIG. 1.

FIG. 3 is a flowchart showing a method for preparing a positive electrode active material for a lithium secondary battery according to another embodiment of the present invention.

FIG. 4 is a schematic view showing a method for preparing a positive electrode for a lithium secondary battery according to still another embodiment of the present invention.

FIG. 5 is SEM images of positive electrode active materials according to NCA (A), Preparation Example 1 (B), Preparation Example 2 (B), Preparation Example 3 (C), and Preparation Example 4 (D).

FIG. 6 is a graph showing specific surface areas of NCA (CNT 0 wt %), Preparation Example 1 (CNT 0.5 wt %), Preparation Example 2 (CNT 0.75 wt %), and Preparation Example 3 (CNT 1 wt %).

FIG. 7 is a graph of comparing powder conductivity of Super-P, MWCNT, NCA (CNT 0 wt %), Preparation Example 1 (CNT 0.5 wt %), Preparation Example 2 (CNT 0.75 wt %), and Preparation Example 3 (CNT 1 wt %).

FIG. 8 is a graph of confirming rate-specific discharge characteristics of NCA (CNT 0 wt %), Preparation Example 1 (CNT 0.5 wt %), Preparation Example 2 (CNT 0.75 wt %), and Preparation Example 3 (CNT 1 wt %).

FIG. 9 is a graph showing electrochemical characteristics of positive electrode plates prepared by a dry method with different content ratios of a binder.

FIG. 10 is a graph (A) showing rate-specific characteristics of Comparative Example 3 and Example 4, and a view (B) confirming processability of Comparative Example 1, Comparative Example 3, and Example 4.

FIG. 11 is a result of comparing electrical characteristics of Comparative Example 1 and Example 4. Table 3 shows resistance values of Comparative Example 1 and Example 4.

FIG. 12 is a view showing cross-section of positive electrode plates of Comparative Example 1 and Example 4.

FIG. 13 is a view showing SEM images and EDS mapping images of Comparative Example 1 and Example 4.

FIG. 14 is a view showing electrochemical characteristics of Comparative Example 1 and Example 4.

FIG. 15 is a schematic view showing an effect of the positive electrode according to the present invention.

FIG. 16 is a view showing rate-specific characteristics, charge/discharge profiles, and Nyquist plots of Comparative Example 4 and Example 6.

FIG. 17 is a graph showing cycle characteristics of Comparative Example 1 and Example 6.

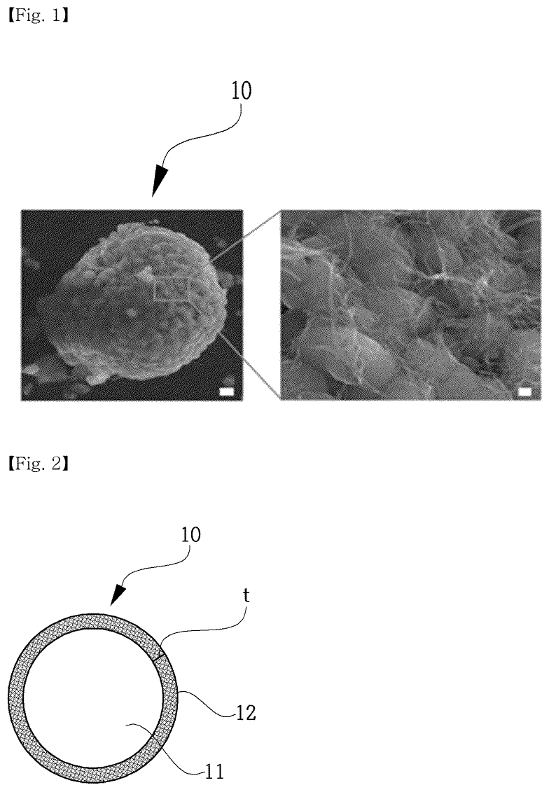

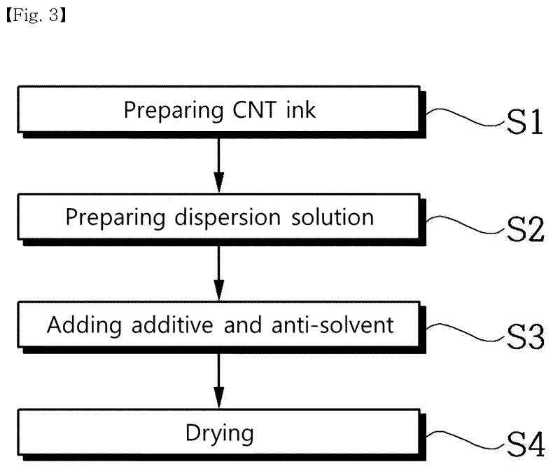

### BEST MODE

A ratio (ID/IG) of the maximum peak intensity of a D band at 1360 nm may be 0.5 to 1.5. As described above, the positive electrode active material may be provided within the above-described range of the Raman spectrum by using the CNT ink and using the carbon nanotubes and the organic compound. A ratio of a surface area (S1) of the lithium transition metal oxide with respect to a surface area (S2) of the positive electrode active material may satisfy Expression 1 below:

$$0.02 \leq S 1 / S 2. \qquad ( Expression 1 )$$

The lithium transition metal oxide may have a surface area (S1) of 0.2 m²/g to 2.5 m²/g.

In addition, the positive electrode active material may have a powder conductivity of 0.01 S/m to 1 S/m under a pressure of 4 kN/cm².

The surface area (S1) of the lithium transition metal oxide needs to be within the above-described range in order for the carbon nanotubes to be physically and firmly attached using the CNT ink. In addition, the positive electrode active material may control the surface area according to the thickness of the surface layer and the content or length of the carbon nanotubes included in the surface layer. The positive electrode active material is provided such that a thickness increase rate with respect to the surface area (S2) of the transition metal oxide is greater than 120%, so that the physical adhesion may be improved using the CNT ink, and the positive electrode active material may have a high powder conductivity as in the above-described range.

The organic compound may include any one or more functional groups of an epoxy group, a carboxyl group, an amino group, an ether group, an amine group, an imide group, a nitrile group, an acrylic group, a double bond, and a triple bond. Specifically, the organic compound may be a nitrile group or an acrylic group.

The lithium transition metal oxide may include secondary particles composed of a group of a plurality of primary particles. The secondary particles may be prepared by preparing a precursor by a co-precipitation method using a transition metal hydroxide solution, and mixing the precursor with a lithium compound and calcining the mixture.

The secondary particles may be represented by Chemical Formula 1 below, and the secondary particles may have an average particle diameter (D50) of 2 μm to 30 μm and a BET specific surface area of 0.1 m²/g to 1.0 m²/g:

LiₐNi_{1-x-y}CoₓM1_{y}O₂ [Chemical Formula 1]
(wherein M1 is any one or at least two elements selected from the group consisting of Mn, Al, Zr, Ti, Mg, Ta, Nb, W, Mo, and Cr, and satisfies 1.0≤a≤1.5, 0≤x≤0.5, 0≤y≤0.5, and 0≤x+y≤0.5).

Alternatively, the lithium transition metal oxide may include single particles and a plurality of fine particles attached to surface of the single particles. The single particles are formed of approximately one particle, and the fine particles may be attached to the surface. The fine particles may have an average particle diameter (D50) of 0.01 to 0.1 times the average particle diameter of the single particles. The fine particles may be represented by Chemical Formula 1 or may be provided in various forms such as a compound using residual lithium.

The single particles may be represented by Chemical Formula 1 below, and the single particles may have an average particle diameter (D50) of 2 μm to 10 μm and a BET specific surface area of 0.5 m²/g to 2.5 m²/g:

LiₐNi_{1-x-y}CoₓM1_{y}O₂ [Chemical Formula 1]
(wherein M1 is any one or at least two elements selected from the group consisting of Mn, Al, Zr, Ti, Mg, Ta, Nb, W, Mo, and Cr, and satisfies 1.0≤a≤1.5, 0≤x≤0.5, 0≤y≤0.5, and 0≤x+y≤0.5).

Specifically, the lithium transition metal oxide may include 50 mol % or greater of nickel (Ni), a content ratio of the carbon nanotubes with respect to the lithium transition metal oxide may be 0.1 wt % to 1 wt %, and the carbon nanotubes are in an amount of 30 parts by weight to 80 parts by weight based on total 100 parts by weight of the carbon nanotubes and the organic compound.

The positive electrode active material according to the present embodiment may include 0.1 wt % to 1 wt % of carbon nanotubes even if the positive electrode active material includes a high content of nickel, thereby improving conductivity, and side reactions with an electrolyte may be reduced, thereby improving cycle characteristics of the lithium secondary battery.

The surface layer may be provided by impregnating the lithium transition metal oxide in the CNT ink and physically applying a force thereto.

FIG. 3 is a flowchart showing a method for preparing a positive electrode active material for a lithium secondary battery according to another embodiment of the present invention.

The method for preparing a positive electrode active material for a lithium secondary battery may include: a step S1 of preparing a CNT ink by adding a carbon nanotube raw material and an organic compound to an organic solvent; a step S2 of preparing a dispersion solution by adding a lithium transition metal oxide to the CNT ink; a step S3 of adding an additive and an anti-solvent to the dispersion solution; and a step S4 of drying a mixture thereof in an oven at a temperature of 120° C. to 180° C. for 1 hour to 24 hours.

The carbon nanotube raw material may be included in the CNT ink to form a surface layer of the positive electrode active material by the method for preparing a positive electrode active material for a lithium secondary battery. The carbon nanotubes included in the surface layer may be formed in the form of a bundle by partially concentrating 1 to 10 single-walled carbon nanotubes or multi-walled carbon nanotubes, the bundle form may have a diameter of 2 nm to 35 nm and a length of 1 μm to 50 mm (preferably 1 mm˜50 mm or preferably 10 μm˜10 mm), and as components of the carbon nanotubes, a content of oxygen atoms with respect to carbon atoms may be 0.01 mol % to 10 mol %. Specifically, the carbon nanotube raw material and the carbon nanotubes constituting the surface layer may be provided with the same or similar physical properties.

The organic solvent may include any one or more of N-methyl-2-pyrrolidone (NMP), polypyrrolidone, isopropanol, petroleum ether, tetrahydrofuran, ethyl acetate, N, N-dimethylacetamide, N, N-dimethylformamide, n-hexane, and halogenated hydrocarbon.

The organic compound may include any one or more of polyacrylonitrile (PAN), polyvinyl pyrrolidone (PVP), polyvinyl alcohol (PVA), polyacrylic acid (PAA), and polyamideimide (PAI).

The anti-solvent may include any one or more of ultrapure water, methanol, acetone, and ethanol.

The additive may include any one or more of a chloride, a carbonate, a hydroxide, and a nitrate of metal.

The metal may include an alkali metal or an alkaline earth metal. Specifically, the chloride of the metal may be LiCl, NaCl, KCl, MgCl₂, or CaCl₂), the carbonate of the metal may be Li₂CO₃, Na₂CO₃, NaHCO₃, K₂CO₃, MgCO₃, or CaCO₃, the hydroxide of the metal may be LiOH, NaOH, KOH, Mg(OH)₂, or Ca(OH)₂, and the nitrate of the metal may be LiNO₃, NaNO₃, KNO₃, Mg(NO₃)₂, or Ca(NO₃)₂.

The CNT ink may include the carbon nanotubes and the organic compound, which are dispersed in the organic solvent, and specifically, at least a portion of the organic compound may be uniformly dispersed in the surface of the carbon nanotubes and physically bonded thereto. For example, the CNT ink may be provided in the form in which the carbon nanotubes having the organic compound attached thereto is dispersed in the organic solvent.

The step S1 of preparing the CNT ink may include ultrasonically mixing for 0.5 hour to 12 hours. Upon the ultrasonic mixing, tip-sonication is used, but the ultrasonic mixing may be performed one to five times at 20 kHz to 100 kHz. Specifically, in the step S1 of preparing the CNT ink, the ultrasonic mixing may be performed for 0.5 hour to 10 hours, 0.5 hour to 7 hours, or 1 hour to 5 hours.

In the step S1 of preparing the CNT ink, upon ultrasonic mixing, when the ultrasonic wave is less than 20 kHz, it is difficult for the organic compound to be uniformly attached to the carbon nanotubes, and when the ultrasonic wave is greater than 100 kHz, it is difficult for the carbon nanotubes to be formed in a reticular form.

The dispersion solution may be prepared by adding the lithium transition metal oxide in the CNT ink, and the lithium transition metal oxide is present in the form in which the lithium transition metal oxide is uniformly dispersed in the carbon nanotubes having the organic compound attached thereto.

The step S2 of preparing the dispersion solution may include physically stirring for 0.5 hour to 72 hours. Upon the physical stirring, stirring may be performed at 1000 rpm to 10,000 rpm, and when the stirring speed is lower than 1000 rpm, it is difficult to uniformly disperse the lithium transition metal oxide in the dispersion solution, and when the stirring speed is higher than 10,000 rpm, it is difficult to form a reticular surface layer with a uniform thickness on the surface of the lithium transition metal oxide. In addition, upon physical stirring, when the stirring time is shorter than 0.5 hour, a problem such as a partial agglomeration of the lithium transition metal oxide occurs in the CNT ink, and since the dispersion solution may be sufficiently prepared for 72 hours, there is a problem in that the preparation time is increased when the stirring time is longer than 72 hours.

By adding the additive and the anti-solvent to the dispersion solution, a micelle-like form may be formed in which the carbon nanotubes, which have the organic compound attached to a part adjacent to the surface of the lithium transition metal oxide, are surrounded at a high concentration. In the micelle-like form, the carbon nanotubes having the organic compound attached thereto, are provided adjacent to the lithium transition metal oxide, and are physically bonded by one or more of pi bond, sigma bond, hydrogen bond, and van der Waals interaction. In addition, during stirring, the carbon nanotubes having the organic compound attached thereto may be more strongly bonded to the lithium transition metal oxide by a pressure caused by the organic solvent and the anti-solvent. In this case, the carbon nanotubes may be provided in a reticular form due to a steric hindrance between carbon nanotubes adjacent to each other, in which some of the carbon nanotubes may be attached in a point-to-point manner and other carbon nanotubes may be spaced apart from each other to form a space.

The step S3 of adding the additive and the anti-solvent may include physically stirring for 5 minutes to 1 hour at 100 rpm to 5000 rpm after adding the additive and the anti-solvent. In the step S3 of adding the additive and the anti-solvent, when stirring is performed for shorter than 5 minutes, the surface layer is not uniformly formed, and when stirring is performed for longer than 1 hour, it is difficult to form the carbon nanotubes inside the surface layer in a reticular form because the carbon nanotubes are densely attached to each other. In addition, when stirring is performed at lower than 100 rpm, it is difficult for the surface layer to be firmly attached to the lithium transition metal oxide, and when stirring is performed at higher than surface layer may be reversely 5000 rpm, the attached detached. Specifically, the additive and the anti-solvent may be first mixed at room temperature and added to the dispersion solution.

The step S4 of drying may further include selecting a solid-phase material before putting the same in an oven. The solid-state material may be selected by removing a liquid-state material by a method such as a filter or a centrifugal separator, and selecting only the solid-state material.

In addition, the selected solid-phase material may be dried in the oven at a temperature of 120° C. to 180° C. for 2 hours to 24 hours, and when the temperature in the oven is lower than 120° C., a residual solvent such as the organic solvent or the anti-solvent may not be sufficiently dried, and when the temperature in the oven exceeds 180° C., the reticular form in the surface layer may not be maintained during drying the solvent, and some carbon nanotubes may be attached to each other.

According to still another aspect of the present invention, the present invention relates to a positive electrode for a lithium secondary battery including the above-described positive electrode active material, a binder, and a conductive material, in which the positive electrode for a lithium secondary battery may include 0.2 parts by weight to 3 parts by weight of the binder and 0 parts by weight to 5 parts by weight of the conductive material based on total 100 parts by weight of the positive electrode active material, the binder, and the conductive material.

In general, the positive electrode active material necessarily includes a binder for bonding particles and a conductive material for improving an electrical conductivity. On the other hand, there is a problem in that the binder and the conductive material relatively reduce the specific capacity of the positive electrode, and the production cost is increased in order to uniformly mix the binder and the conductive material with the positive electrode active material. In addition, since the conductive material is present as particles separate from the positive electrode active material, volume expansion of the positive electrode active material occurs during performing the cycle, and there is a problem in that the ability of the conductive material to improve an electrical conductivity between positive electrode active materials is deteriorated.

Meanwhile, the positive electrode active material according to the present embodiment may include carbon nanotubes on the surface layer. The carbon nanotubes may have a function similar to that of the conductive material, thereby reducing the content of the conductive material added to the positive electrode to 5 parts by weight or less. Specifically, the conductive material may not be added. The content of the conductive material may be 0 part by weight to 5 parts by weight, specifically 0 parts by weight to 4 parts by weight, 0 part by weight to 3 parts by weight, 0.5 part by weight to 3 parts by weight, or 1 part by weight to 3 parts by weight, based on total 100 parts by weight of the positive electrode active material, the binder, and the conductive material.

In addition, in the positive electrode active material according to the present embodiment, the content of the binder may also be reduced in comparison to the content of the binder generally included. The surface layer may function similar to a buffer between neighboring positive electrode active materials, thereby maintaining a position of the neighboring positive electrode active materials at the same time.

In the positive electrode for a lithium secondary battery according to the present embodiment, even when contraction and expansion of a volume of the positive electrode active material occur during charging and discharging, positional deformation of the positive electrode active material may be reduced by the surface layer, thereby reducing the content of the binder.

The content of the binder may be 0.2 parts by weight to 3 parts by weight based on total 100 parts by weight of the positive electrode active material, the binder, and the conductive material. Specifically, the content of the binder may be 0.2 parts by weight to 2.5 parts by weight, 0.2 parts by weight to 2 parts by weight, 0.5 parts by weight to 3 parts by weight, 0.5 parts by weight to 2.5 parts by weight, or 1 part by weight to 2.5 parts by weight.

The conductive material may include any one or more of carbon nanotubes, graphene, graphite, carbon black, and carbon fiber. For example, the conductive material may include graphite such as carbon nanotubes, graphene, natural graphite, and artificial graphite, carbon black such as acetylene black, Ketjen black, channel black, furnace black, lamp black, summer black, Super-P, toka black, and denka black, carbon fibers, and the like. More specifically, the conductive material may be carbon nanotubes or graphene.

The binder may include any one or more of polyvinylidene fluoride (PVDF), polytetrafluoroethylene (PTFE), polyacrylic acid (PAA), and polyamideimide (PAI).

Alternatively, the positive electrode for a lithium secondary battery may be prepared by mixing only the positive electrode active material, the conductive material, and the binder without using a solvent, or a solid-phase material formed of only the positive electrode active material and the binder. For example, when the solvent is not used in the positive electrode for a lithium secondary battery, the binder may be provided in the form of fibril having a fibrous structure when a physical force is applied thereto, and specifically, may be polytetrafluoroethylene (PTFE).

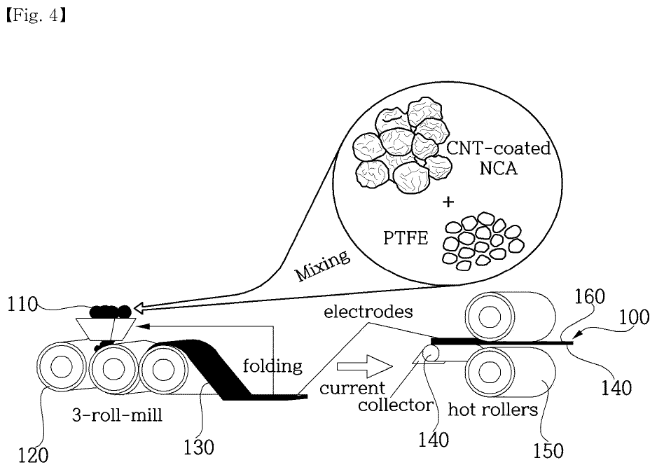

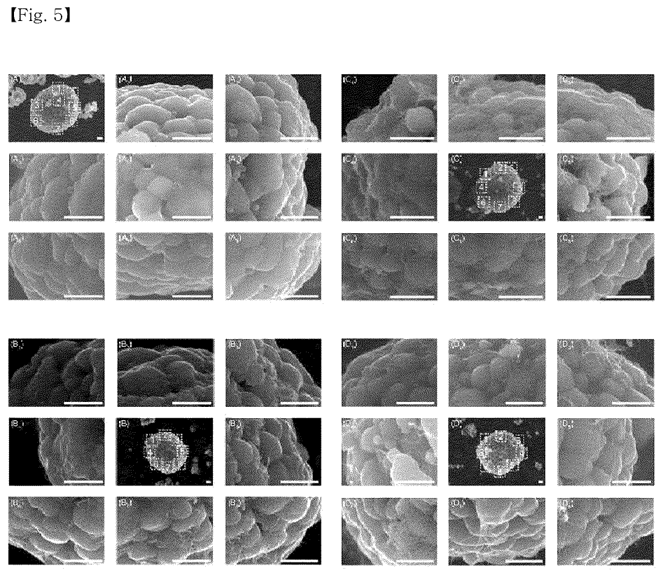

FIG. 4 is a schematic view showing a method for preparing a positive electrode for a lithium secondary battery according to still another embodiment of the present invention.

Referring to FIG. 4, the method for preparing a positive electrode 100 for a lithium secondary battery according to the present embodiment may include: a step of preparing a positive electrode mixture raw material 110 by physically mixing the above-described positive electrode active material and a powdered binder at room temperature; a step of preparing the positive electrode mixture raw material 110 into a sheet-shaped preliminary positive electrode layer 130 using a rolling roll 120; and a step of preparing the positive electrode by 100 attaching the sheet-shaped preliminary positive electrode layer 130 to at least one surface of a current collector 140 and pressing the sheet-shaped preliminary positive electrode layer 130 using a heating roll 150 at a temperature of 20° C. to 350° C.

The positive electrode 100 may be provided by laminating one or more sheet-shaped positive electrode layers 160 and one or more current collectors 140, and the sheet-shaped positive electrode layer may have a loading level of 10 mg/cm² to 50 mg/cm².

In general, the positive electrode for a lithium secondary battery is prepared by forming a slurry using N-methyl-2-pyrrolidone (NMP) as an organic solvent, coating the slurry on the current collector, and drying the slurry. In such a method, a separate treatment system is required in order to mass produce and recover the solvent, which may increase manufacturing costs and treatment time and have a negative impact on the environment. In addition, during drying the solvent, a non-uniform particle distribution occurs between upper and lower portions of the positive electrode, which causes a problem.

On the other hand, in the present embodiment, the positive electrode active material may include a lithium transition metal oxide and a surface layer, and the surface layer may include carbon nanotubes in a reticular form and an organic compound. The positive electrode active material according to the present embodiment may be formed as a sheet-shaped preliminary positive electrode layer having a pellet-like shape even by simply mixing with the binder without using a solvent. For example, the binder may be formed in a fibrous structure during preparation of the positive electrode mixture raw material, and the fibrous structure formed as described above may be formed in the form in which the binder is tangled with the carbon nanotubes of the surface layer to more firmly fix the positive electrode active material. The positive electrode for a lithium secondary battery according to the present embodiment may be prepared without using a solvent, and thus may be prepared in an ecofriendly manner while reducing raw material costs.

The step of preparing the positive electrode mixture raw material 110 may include stirring and mixing the positive electrode active material and the powdered binder at room temperature. Specifically, in the step of preparing the positive electrode mixed raw material 110, chopping, primary rolling, high-speed RPM stirring, and secondary rolling may be sequentially performed. The chopping may be performed using a chopping apparatus, and the positive electrode active material and the binder may be uniformly mixed. The primary rolling may be performed by introducing the positive electrode active material and the binder into a drum at room temperature and rotating the drum for 1 minute to 30 minutes. The high-speed RPM stirring may be performed at 500 rpm to 10000 rpm for 30 seconds to 1 hour. The secondary rolling may be performed for 10 minutes to 1 hour after the cathode active material and the binder, which have been subjected to the high-speed RPM stirring, are introduced into the drum. By mixing the positive electrode active material and the binder through the above-described method, the positive electrode active material and the binder may be uniformly mixed, and the binder may be uniformly attached to the surface of the positive electrode active material without damage to the positive electrode active material.

In the step of preparing the positive electrode mixture raw material 110, the positive electrode active material and the binder may be mixed by mixing the positive electrode active material composed of only a solid phase and the binder without using a solvent, and performing the chopping, the primary rolling, the high-speed RPM stirring, and the secondary rolling to prepare the positive electrode mixture raw material 110. In the positive electrode mixture raw material 110, the binder may be formed in a fibrous structure to cover the surface of the positive electrode active material and connect neighboring positive electrode active materials to each other.

In the step of preparing the sheet-shaped preliminary positive electrode layer 130, the rolling roll 120 may apply a pressure of 5 to 100 kgf/cm at a temperature of 20° C. to 350° C., and in the step of preparing the sheet-shaped preliminary positive electrode layer, the binder included in the sheet-shaped preliminary positive electrode layer 130 may be dispersed in a fibril form having a fibrous structure.

During preparation of the positive electrode mixture raw material 110, the binder may be provided in a tangled form so as to primarily cover the surface of the positive electrode active material, and during preparation of the sheet-shaped preliminary positive electrode layer 130, the binder may be provided to cover the positive electrode active material with a larger area while being secondarily stretched under a tensile force.

The rolling roll 120 may apply a pressure of 5 kgf/cm to 100 kgf/cm at a temperature of 20° C. to 350° C. When the temperature of the rolling roll 120 is lower than 20° C., the binder is not sufficiently fixed to the positive electrode active material, and when the temperature is higher than 350° C., the prepared sheet-shaped preliminary positive electrode layer 130 is not maintained in a fixed form at room temperature, so that it is difficult to perform a continuous process. In addition, when the pressure of the rolling roll 120 is maintained in the above-described range, the shape of the sheet-shaped preliminary positive electrode layer 130 is maintained, and the positive electrode active material inside thereof may be well fixed without being broken the pressure.

The sheet-shaped preliminary positive electrode layer 130 may be attached to a sheet-shaped current collector and press the same using the heating roll 150 to prepare the positive electrode 100. The positive electrode 100 may be formed by further compressing the sheet-shaped preliminary positive electrode layer 130 to form a sheet-shaped positive electrode layer 160, and the sheet-shaped positive electrode layer 160 may be laminated on the current collector 150.

The heating roll 140 may apply a pressure of 5 kgf/cm to 100 kgf/cm at a temperature of 20° C. to 350° C. When the heating roll 140 is maintained in the above-described temperature range, the sheet-shaped preliminary positive electrode layer may be formed into a sheet-shaped positive electrode layer having a predetermined electrode density, and the sheet-shaped positive electrode layer may be maintained on the current collector without being broken or detached. In addition, when the pressure of the heating roll 140 is less than 5 kgf/cm, the current collector and the sheet-shaped positive electrode layer are not well attached, which causes a problem, and when the pressure of the heating roll 140 exceeds 100 kgf/cm, the sheet-shaped positive electrode layer is broken or wrinkles are formed in the current collector.

The sheet-shaped positive electrode layer 160 prepared as described above may have a loading level of 10 mg/cm² to 50 mg/cm². Specifically, the sheet-shaped positive electrode layer may have a loading level of 10 mg/cm² to 40 mg/cm², 10 mg/cm² to 300 mg/cm², 15 mg/cm² to 50 mg/cm², or 15 mg/cm² to 30 mg/cm².

The powdered binder may include at least one of polyvinylidene fluoride (PVDF), polytetrafluoroethylene (PTFE), polyacrylic acid (PAA), and polyamideimide (PAI), and

In addition, the powdered binder may be included in an amount of 0.4 parts by weight to 5 parts by weight based on 100 parts by weight of the positive electrode active material. When the content of the binder is less than 0.4 parts by weight, it is difficult to prepare a sheet shape by fixing the positive electrode active material, and when the content of the binder is greater than 5 parts by weight, unnecessary binder content increases and the specific capacity of the positive electrode is reduced, which causes a problem.

Alternatively, in the step of preparing the positive electrode mixture raw material, a conductive material may be further included. When the conductive material is further included, the positive electrode for a lithium secondary battery may include 0 parts by weight to 5 parts by weight of the conductive material and 0.2 parts by weight to 3 parts by weight of the binder based on total 100 parts by weight of the positive electrode active material, the binder, and the conductive material.

The positive electrode active material may have an average particle diameter (D50) of 2 μm to 30 μm, and the powdered binder may have an average particle diameter (D50) of 2 μm to 800 μm. In addition, the strength of the positive electrode active material may be 80 MPa or greater, and specifically, the strength of the positive electrode active material may be 80 MPa to 1000 MPa, 100 MPa to 1000 MPa, 150 MPa to 1000 MPa, or 80 MPa to 500 MPa.

In addition, when the particle size of the powdered binder is less than 2 μm, the binder is scattered during preparation of the positive electrode for a lithium secondary battery, resulting in a large amount of process loss, and when the particle size exceeds 800 μm, dispersion is difficult during preparation of the powdered binder in a sheet shape, and a high temperature and a high pressure are required, which causes problems such as breakage of the positive electrode active material.

The thickness of the sheet-shaped positive electrode layer may be 50 μm to 500 μm, the thickness of the sheet-shaped positive electrode layer may be 30 μm to 200 μm, the density of the sheet-shaped positive electrode layer may be 30% to 90% with respect to the density of the sheet-shaped positive electrode layer, and the electrical conductivity of the sheet-shaped positive electrode layer may be 0.1 S/cm or greater.

In the positive electrode for a lithium secondary battery according to the present embodiment, the positive electrode may be prepared by a solvent-free process, and may be primarily rolled to prepare the sheet-shaped preliminary positive electrode layer, and may be secondarily rolled to prepare the sheet-shaped positive electrode layer laminated on the current collector. By preparing the sheet-shaped preliminary positive electrode layer and the sheet-shaped positive electrode layer at the above-described thickness and density, physical and electrical properties of the final positive electrode may be improved, and a large amount of the sheet-shaped preliminary positive electrode layer and the sheet-shaped positive electrode layer may be prepared without using a solvent.

The current collector may have a thickness of 3 μm to 500 μm and a tensile strength of 135 N/mm² to 265 N/mm², and the current collector may include any one or more of aluminum, stainless steel, nickel, titanium, and calcined carbon.

The current collector needs to be provided with the above-described thickness and tensile strength, so that the current collector may be well attached to the sheet-shaped positive electrode layer during secondary rolling and may be well maintained without cracking in the positive electrode.

Hereinafter, examples and comparative examples of the present invention will be described. However, the following examples are only preferred examples of the present invention, and the scope of the present invention is not limited by the following examples.

### 1. Preparation of Positive Electrode Active Material Having Surface Layer

### Preparation Example 1 (CNT 0.5 wt %)

0.5 g of multi-walled carbon nanotube powder (CM-280, Hanwha Co. Ltd.) and 0.5 g of polyacrylonitrile (PAN, Aldrich Corporation) were added to 99 g of N, N-dimethylformamide (DMF, at room temperature, an ultrasonic Aldrich Corporation) treatment was performed using tip sonication at 50 Hz for 30 minutes to prepare a CNT ink having 0.5 wt % of carbon nanotubes. 3 g of lithium transition metal oxide was added to the prepared CNT ink such that a weight ratio of 3 g of lithium transition metal oxide (NCA), which was represented by LiNi_{0.8}CO_{0.2}Al_{0.02}O₂, and the CNT ink was 2:1. Thereafter, a dispersion solution was prepared by voltex mixing at 1000 rpm for 5 minutes. 1 g of NaCl and 50 g of ethanol were added to the prepared dispersion solution, vortex-mixed at 1000 rpm for 5 minutes, and centrifuged at 1000 rpm for 5 minutes to separate only a solid-phase material from the mixture. The separated solid-phase material was washed with ethanol to remove residual carbon nanotubes and vacuum-dried at 150° C. for 5 hours to prepare a positive electrode active material coated with carbon nanotubes and an organic material (PAN).

### Preparation Example 2 (CNT 0.75 wt %) and Preparation Example 3 (CNT 1 wt %)

A positive electrode active material was prepared in the same manner as in Preparation Example 1, except that a CNT ink having 0.75 wt % of carbon nanotubes and a CNT ink having 1 wt % were used in Preparation Examples 2 and 3, respectively.

### 3. Preparation of Positive Electrode Plate

### Comparative Example 1 (Wet Method, NCA Positive Electrode Plate)

In N, N-dimethylformamide (DMF, Aldrich Corporation), 96 wt % of LiNi_{0.8}Co_{0.2}Al_{0.02}O₂ lithium transition metal oxide (NCA) (NCA without coated with carbon nanotubes, bare NCA) used in Preparation Example 1 was mixed with 2 wt % of carbon black (Super-P) as a conductive material and 2 wt % of poly(vinylidene fluoride) (PVdF, Solef 6020, Solvay) as a binder to prepare a slurry. The prepared slurry was coated on an Al foil to have a thickness of 15 μm using a doctor blade. Thereafter, the slurry was primarily dried in a convection oven at 80° C. for 1 hour and vacuum-dried at 120° C. for 12 hours to prepare a positive electrode plate.

### Comparative Example 2 (Dry Method, NCA Positive Electrode Plate)

98 wt % of LiNi_{0.8}Co_{0.2}Al_{0.02}O₂ lithium transition metal oxide (NCA) (NCA without coated with carbon nanotubes, bare NCA) used in Preparation Example 1 was mixed with 2 wt % of polytetrafluoroethylene (PTFE, Dupont) powder as a binder using a mixer until a single flake was formed. The prepared mixture was prepared in a sheet shape having a thickness of 150 μm using a 3-axis rolling roll (H3RM-50, HANTECH LTD.). Thereafter, the prepared sheet shape was attached to an Al foil having a thickness of 15 μm, and roll-pressed at 80° C. to prepare a positive electrode plate having a positive electrode layer having a thickness of 100 μm.

### Comparative Example 3 (Wet Method, CNT 0.75 wt % NCA Positive Electrode Plate)

A positive electrode plate was prepared in the same manner as in Comparative Example 1, except that the positive electrode active material of Preparation Example 2 (NCA coated with 0.5 wt % of CNT) was used instead of NCA, and 99.6 wt % of the positive electrode active material was mixed with 0 wt % of carbon black (Super-P) as a conductive material and 0.4 wt % of poly(vinylidene fluoride) (PVdF, Solef 6020, Solvay) as a binder.

### Comparative Example 4 (Wet Method, NCA Positive Electrode Plate)

A positive electrode plate was prepared in the same manner as in Comparative Example 1, except that only the loading level is increased to 40 mg/cm².

### Example 1

98 wt % of the positive electrode active material (NCA coated with 0.5 wt % of CNT) of Preparation Example 1 and 2 wt % of polytetrafluoroethylene (PTFE, Dupont) powder as a binder were mixed using a mixer until a single flake was formed. The prepared mixture was prepared in a sheet shape having a thickness of 150 μm using a 3-axis rolling roll (H3RM-50, HANTECH LTD.). Thereafter, the prepared sheet shape was attached to an Al foil having a thickness of 15 μm, and roll-pressed at 80° C. to prepare a positive electrode plate having a positive electrode layer having a thickness of 100 μm.

### Examples 2 and 3

A positive electrode plate was prepared in the same manner as in Example 1, except that the positive electrode active material of Preparation Example 2 (NCA coated with 0.75 wt % of CNT) and the positive electrode active material of Preparation Example 3 (NCA coated with 1 wt % of CNT) were used.

### Example 4

99.6 wt % of the positive electrode active material (NCA coated with 0.75 wt % of CNT) of Preparation Example 2 and 0.4 wt % of polytetrafluoroethylene (PTFE, Dupont) powder as a binder were mixed using a mortar until a single flake was formed. The prepared mixture was prepared in a sheet shape having a thickness of 150 μm using a 3-axis rolling roll (H3RM-50, HANTECH LTD.). Thereafter, the prepared sheet shape was attached to an Al foil having a thickness of 15 μm, and roll-pressed at 80° C. to prepare a positive electrode plate having a positive electrode layer having a thickness of 100 μm.

### Example 5

A positive electrode was prepared in the same manner as in Example 4 except that the contents of the positive electrode active material and the binder were 99 wt % and 1 wt %, respectively.

### Example 6

A positive electrode plate was prepared in the same manner as in Example 4, except that only the loading level is increased to 40 mg/cm².

TABLE 1

| | Positive | | Positive Electrode Active | | |
|---|---|---|---|---|---|
| | Electrode | | Material:Conductive | Loading | Electrode |
| | Active | Preparation | Material:Binder | Level | Density |
| Classification | Material | Method | (Weight Ratio) | (mg/cm²) | (ρ, g/cm³) |
| Comparative | NCA | Wet | 96:02:02 | 40 mg/cm² | 3.6 g/cm³ |
| Example 1 | (CNT 0 wt %) | Method | | | |
| Comparative | NCA | Dry | 98:00:02 | 40 mg/cm² | 3.9 g/cm³ |
| Example 2 | (CNT 0 wt %) | Method | | | |
| Comparative | Preparation | Wet | 99.6:0:0.4 | 40 mg/cm² | 4 g/cm³ |
| Example 3 | Example 2 | Method | | | |
| | (CNT 0.75 wt %) | | | | |
| Comparative | NCA | Wet | 96:02:02 | 40 mg/cm² | 3.6 g/cm³ |
| Example 4 | (CNT 0 wt %) | Method | | | |
| Example 1 | Preparation | Dry | 98:00:02 | 40 mg/cm² | 3.9 g/cm³ |
| | Example 1 | Method | | | |
| | (CNT 0.5 wt %) | | | | |
| Example 2 | Preparation | Dry | 98:00:02 | 40 mg/cm² | 3.9 g/cm³ |
| | Example 2 | Method | | | |
| | (CNT 0.75 wt %) | | | | |
| Example 3 | Preparation | Dry | 98:00:02 | 40 mg/cm² | 3.9 g/cm³ |
| | Example 3 | Method | | | |
| | (CNT 0.75 wt %) | | | | |
| Example 4 | Preparation | Dry | 99.6:0:0.4 | 40 mg/cm² | 4 g/cm³ |
| | Example 2 | Method | | | |
| | (CNT 0.75 wt %) | | | | |
| Example 5 | Preparation | Dry | 99:00:01 | 40 mg/cm² | 3.9 g/cm³ |
| | Example 2 | Method | | | |
| | (CNT 0.75 wt %) | | | | |
| Example 6 | Preparation | Dry | 99.6:0:0.4 | 40 mg/cm² | 4 g/cm³ |
| | Example 2 | Method | | | |
| | (CNT 0.75 wt %) | | | | |

### 4. Preparation of Secondary Battery

A half-cell and a pouch-type full-cell were prepared according to the following method.

The half-cell was prepared as a 2032-coin-type half-cell using a working electrode (diameter of 12 mm), a polypropylene separator a (Celgard 2400, Celgard), and lithium metal foil (diameter of 14 mm, Honjo Metal Co. Ltd.) as a negative electrode.

The pouch-type full-cell was prepared by using a positive electrode plate (35 mm×35 mm) and a negative electrode plate (37 mm×37 mm) in a dry room at an N/P ratio of 1.15.

The above-prepared positive electrode plate was used, and as the negative electrode plate, 96 wt % artificial graphite, 1 wt % carbon black (Super-P) as a conductive material, and 3 wt % of a binder containing styrene-butadiene rubber/carboxymethylcellulose (1.5:1.5 wt %) was mixed with each other, coated on a Cu foil having a thickness of 20 μm, and roll-pressed to prepare a graphite negative electrode having a density of 1.5 g/cm³. A stacked electrode including a positive electrode plate, a polyethylene separator (43 mm×43 mm), and a negative electrode plate was vacuum-sealed in an Al pouch, and a liquid electrolyte including a lithium salt of 1.15M LiPF₆ was used, and as the liquid electrolyte, a solution in which 1 wt % of vinylene carbonate and 1 wt % of lithium difluorophosphate were added to a solution, in which ethylene carbonate, ethyl methyl carbonate, and dimethyl carbonate were mixed in a volume ratio of 2:4:4 vol %, was used.

### 5. Electrochemical Evaluation

A constant current charge/discharge test was performed at 30° C. using a charger/discharger (WBCS3000L battery cycler, WonATech). The charge was confirmed by equally charging 0.05 C with cutoff at 0.2 C in a CC-CV mode and discharging at C-rates of 0.2 C, 0.5 C, 1 C, 2 C, and 5 C (1 C=210 mAh/g).

Cycle characteristics were evaluated in a 2.8 V to 4.4 V vs Li/Li⁺ voltage range after charging 0.05 C with cutoff at 0.2 C in the CC-CV mode.

Lithium ion diffusion characteristics were analyzed by cyclic voltammetry (CV) using a charger/discharger (WBCS3000L battery cycler, WonATech). An electrode conductivity was measured using an electrode resistance measurement system (RM2610, Hioki). An electrochemical impedance spectroscopy (EIS) was measured using a Biologic VSP-100 instrument in a frequency range of 1 MHz to 1 mHz with a voltage perturbation of 10 mV. In order to fit EIS data about a symmetric cell including two identical electrodes, a transmission line model (TLM) was used, and the ionic resistance in pores (Rᵢₒₙ) of the electrodes was evaluated. Data fitting was performed using Zview (Scribner Associates, Inc).

### 6. Evaluation of Surface and Physical Properties

Particle shapes and microstructures were confirmed using a scanning electron microscope (SEM) (JSM-7600FM, JEOL) and a Cs-corrected high-resolution transmission electron microscope (TEM) (JEM ARM 200F, JEOL). A single-sided grinder (IB-19530CP, JEOL) was used to prepare a sheared electrode. An electrical conductivity of the powder sample was measured using a four-point probe method (MCP-PD51, Mitsubishi Chemical Analytech) as a function of a pressure applied using a manual hydraulic press. A specific surface area was measured at 77 K using a nitrogen adsorption/desorption isotherm (Tristar II 3020, Micromeritics) and a Brunauer-Emmett-Teller (BET) method.

A content of carbon nanotubes included in the positive electrode active material was measured from 25° C. to 1000° C. at a heating rate of 5° C./min at room temperature using thermogravimetric analysis (TGA, TG/DTA6100, Seiko Exstar 6000). A pore size distribution of 41 the electrode was measured using a mercury intrusion technique (Autopore V), and an electrode resistance map was confirmed by a scanning diffusion resistance microscope (SSRM) which was coupled to an atomic force microscopy (AFM) (NX-10, Parks system) equipped with a diamond coating probe (CDT-NCHR, NANOSENSOR) with a scan region of 30 μm×3030 μm.

### 7. Evaluation and Results

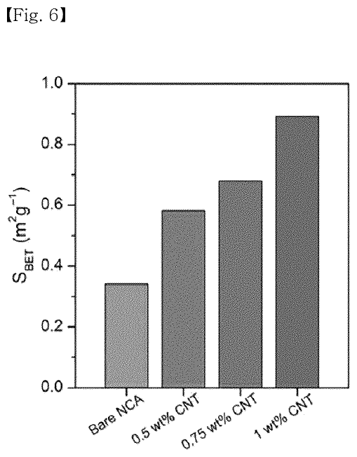

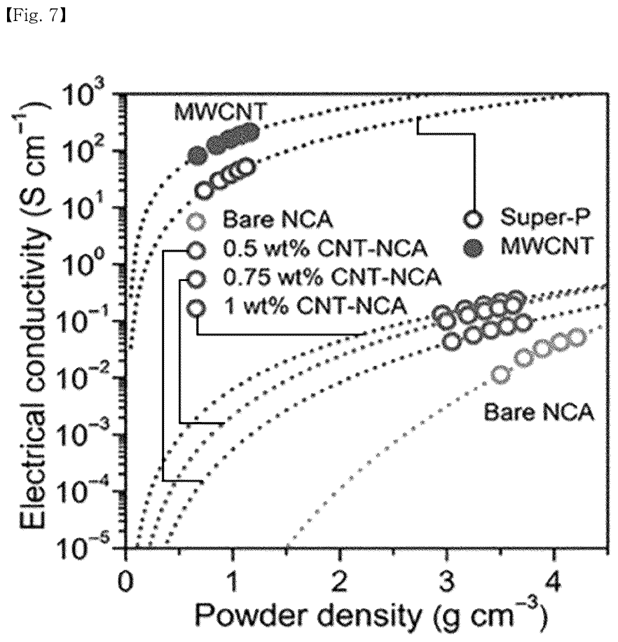

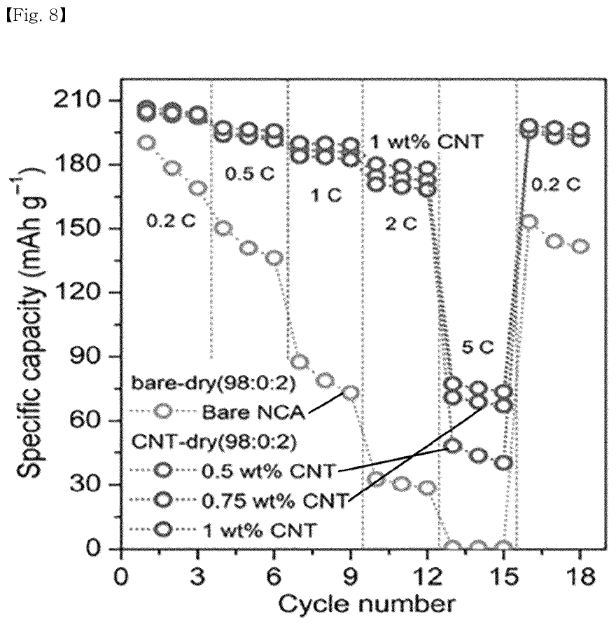

FIG. 5 is SEM images of positive electrode active materials; NCA (A), Preparation Example 1 (B), Preparation Example 2 (B), Preparation Example 3 (C), and Preparation Example 4 (D). FIG. 6 is a graph showing specific surface areas of NCA (CNT 0 wt %), Preparation Example 1 (CNT 0.5 wt %), Preparation Example 2 (CNT 0.75 wt %), and Preparation Example 3 (CNT 1 wt %). FIG. 7 is a graph of comparing powder conductivity of Super-P, MWCNT, NCA (CNT 0 wt %), Preparation Example 1 (CNT 0.5 wt %), Preparation Example 2 (CNT 0.75 wt %), and Preparation Example 3 (CNT 1 wt %), and FIG. 8 is a graph of confirming rate-specific discharge characteristics of NCA (CNT 0 wt %), Preparation Example 1 (CNT 0.5 wt %), Preparation Example 2 (CNT 0.75 wt %), and Preparation Example 3 (CNT 1 wt %). Table 2 shows a specific surface area and a powder conductivity of positive electrode active materials.

TABLE 2

| | | | Positive | | |
|---|---|---|---|---|---|
| | | Lithium | Electrode | | |
| | | Transition | Active | | |
| | | Metal | Material | | |
| | Concen- | Oxide (S1) | (S2) | | |
| | tration | Surface | Surface | | Powder |
| Classifi- | of | Area | Area | | Conductivity |
| cation | CNT Ink | (m²/g) | (m²/g) | S1/S2 | (S/cm) |
| NCA | 0 wt % | 0.1 | 0.1 | 1 | 0.01 |
| Preparation | 0.5 wt % | 0.1 | 0.7 | 0.14 | 0.05 |
| Example 1 | | | | | |
| Preparation | 0.75 wt % | 0.1 | 1.2 | 0.083 | 0.1 |
| Example 2 | | | | | |
| Preparation | 1 wt % | 0.1 | 1.6 | 0.0625 | 0.1 |
| Example 3 | | | | | |

Referring to FIGS. 5, 6, 7, and 8 and Table 2, it was confirmed that the coating amount of carbon nanotubes provided on the surface of the positive electrode active material increased as the concentration of CNT ink increased, and it was also confirmed that the surface area increased as the coating content of the carbon nanotubes increased compared to the NCA that was not coated with the carbon nanotubes. On the other hand, in Preparation Examples 1 to 3, it was confirmed that the three-dimensional reticular form of the carbon nanotubes constituting the surface layer of NCA was similarly maintained. That is, it was confirmed that carbon nanotubes were physically and firmly attached to the surface of NCA without using a carbonization action, a chemical method, or the like.

In FIG. 7, carbon black (CB) and multi-walled carbon nanotubes (MWCNT) were added for comparison. The electrical conductivity of powder was confirmed by a four-point probe method. It was confirmed that the electrical conductivity of the NCA coated with carbon nanotubes increased as the content of carbon nanotubes increased.

The electrical conductivity of the NCA powder coated with CNTs increased as the CNT content increased. When each powder density was 3.9 g/cm³, it was confirmed that the electrical conductivity of the CNT-coated NCA powder was 1.2 to 2.9×10⁻¹ S/cm, which was higher than that of the NCA powder that was not coated with CNTs (˜2.7×10⁻¹ S/cm). When the concentration of the CNT ink was 0.75 wt % and 1 wt %, it may be confirmed that the electrical conductivity was almost similar when the powder density exceeded 3.9 g/cm³.

The positive electrode plates according to Comparative Example 2 and Examples 1 to 3 were prepared by a dry method without using a solvent (see FIG. 3). The dry method includes a method for preparing a positive electrode plate that is laminated with an Al foil through mixing/kneading, forming a three-roll primarily sheet shape, and hot rolling. In this case, the used binder is induced by fibrillation to connect the positive electrode active material in a network form.

FIG. 8 shows rate-specific characteristics of the CNT-coated NCA electrode and the CNT-coated NCA electrode at 0.2 C, 0.5 C, 1 C, 2 C, and 5 C. It was confirmed that the discharge capacity was improved at 0.2 C to 5 C as the CNT concentration increased. The NCA electrode coated with 1 wt % of the CNT ink exhibited higher characteristics compared to the NCA electrode coated with 0.75 wt % of the CNT ink, but the difference thereof was not large, and it was confirmed that some of the carbon nanotubes were provided in the form that was not closely attached to the NCA. Therefore, it was confirmed that 0.75 wt % of the CNT ink was more efficient than the 1 wt % of the CNT ink in order to coat the NCA particles.

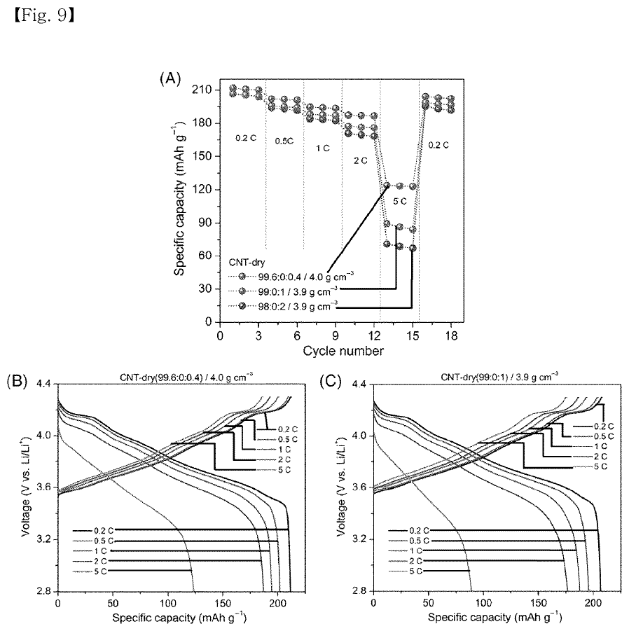

FIG. 9 is a graph showing electrochemical characteristics of positive electrode plates prepared by a dry method with different content ratios of a binder.

Referring to FIG. 9, it was confirmed that Example 4, which is a positive electrode plate having a high NCA content, exhibited a relatively high discharge capacity at 0.2 C to 5 C because the content of the PTFE binder having insulating properties was low. On the other hand, when the PTFE content was lower than 0.4 wt % and 0.3 wt % was used, it was confirmed that the processability was deteriorated, such as cracks occurring during preparation of the positive electrode plate.

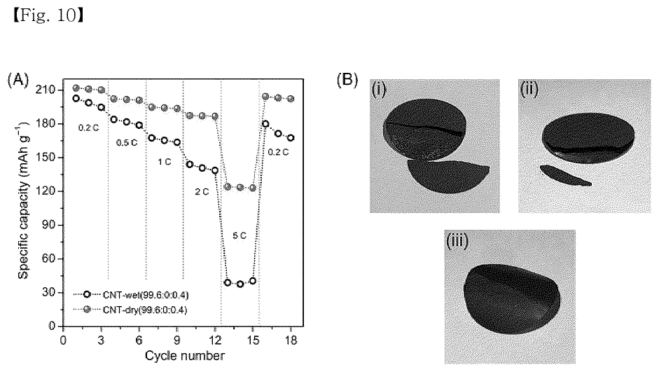

FIG. 10 is a graph (A) showing rate-specific characteristics of Comparative Example 3 and Example 4, and a view (B) confirming processability of Comparative Example 1, Comparative Example 3, and Example 4.

Referring to FIG. 10, when comparing Comparative Example 3 prepared by a wet method and Example 4 prepared by a dry method in the positive electrode active material coated with 0.75 wt % of the CNT ink, it was confirmed that Example 4 prepared by a dry method exhibited improved discharge rate-specific characteristics compared to Comparative Example 3 prepared by a wet method, and the difference thereof increased as the C-rate increased. In addition, in the case of preparation by a wet method, it was confirmed that in Comparative Example 1 and Comparative Example 3, the positive electrode plate was easily destroyed or peeled off from the current collector compared to Example 4 prepared by a dry method. This can be ascribedto be due to a demand of a higher content of the binder in the case of a wet method.

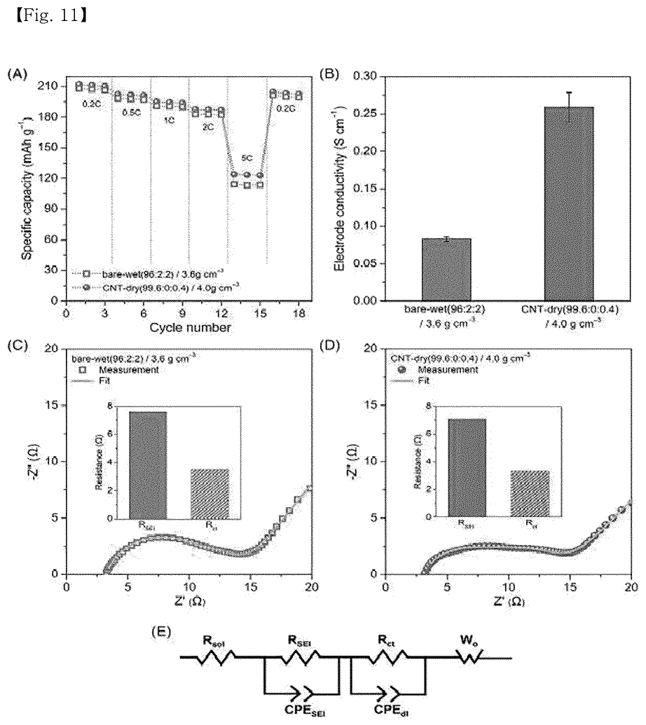

FIG. 11 is a result of comparing electrical characteristics of Comparative Example 1 and Example 4. Table 3 shows resistance values of Comparative Example 1 and Example 4.

TABLE 3

| Classification | bare-wet (96:2:2) | CNT-dry (99.6:0:0.4) |
|---|---|---|
| Rₛₒₗ (92) | 3.252 | 3.033 |
| R_{SEI} ((2) | 7.578 | 7.289 |
| R_{ct} (2) | 3.497 | 4.339 |

In FIG. 11, FIG. 11(A) shows rate-specific characteristics of 0.2 C to 5 C of Comparative Example 1 and Example 4, FIG. 11(B) shows an electrical conductivity, FIGS. 11(C) and 11(D) show resistance characteristics of Comparative Example 1 and Example 4, and FIG. 11(E) shows a contact resistance (R_{cont}) and charge transfer resistance (R_{ct}) evaluated by an equivalent circuit.

Example 4 (φ=99.6:0:0.4 and ρ=4.0 g/cm³) was represented as “CNT-dry (99.6:0:0.4)”, and Comparative Example 1 (φ=96:2:2 and ρ=3.6 g/cm³) was represented as “bare-wet (96:2:2)”, thereby comparing a positive electrode plate prepared by a dry method and a positive electrode plate prepared by a wet method.

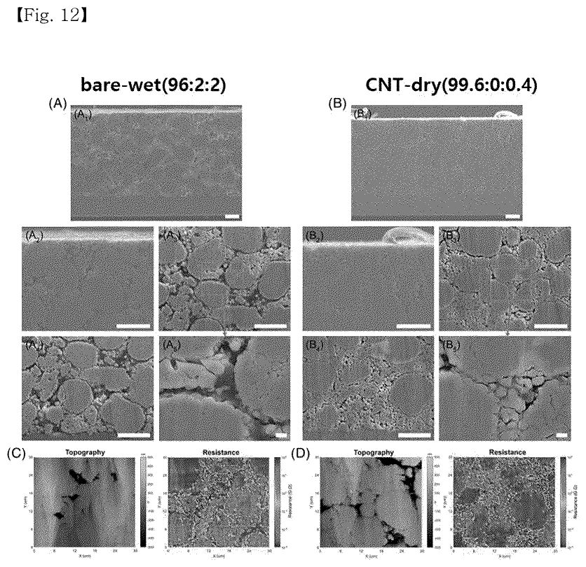

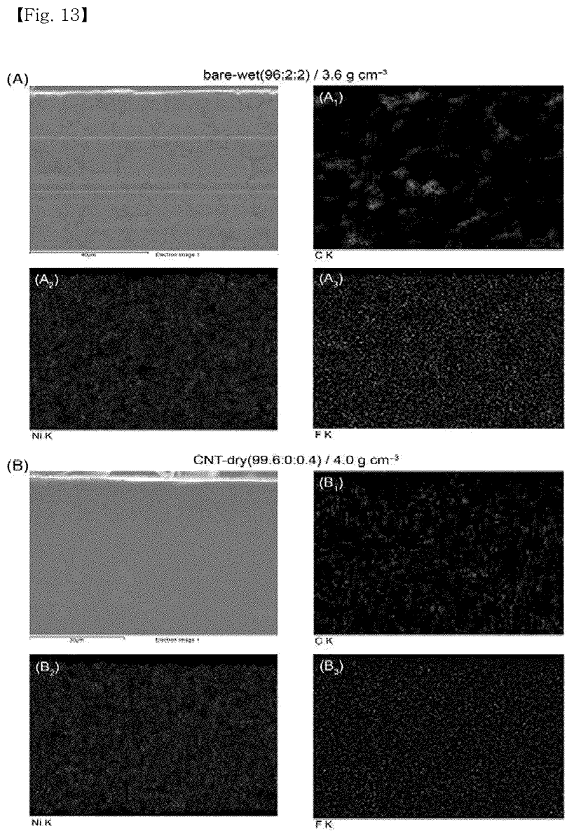

As shown in FIG. 11(A), it was confirmed that CNT-dry (99.6:0:0.4) prepared by a dry method was excellent in the rate-specific characteristics, and it was confirmed that the difference thereof was particularly larger in the high rate. This can be ascribed to be the formation of a coating layer including carbon nanotubes having a network structure on the surface of the positive electrode active material used in Example 4 and the formation of a denser microstructure in the positive electrode plate, as compared to the wet method. Referring to the Nyquist plots in FIGS. 11(C) and 11(D), FIG. 11(E), and Table 3, between CNT-dry (99.6:0:0.4) and bare-wet (96:2:2) in the solid electrolyte interface (SEI) resistance (R_{SEI}) and the charge transfer resistance (R_{ct}), it was confirmed that CNT-dry (99.6:0:0.4) provided an excellent conductive path even though a conductive material was not included and a very low concentration of binder was contained. FIG. 12 is a view showing cross-section of positive electrode plates of Comparative Example 1 and Example 4. FIG. 13 is a view showing SEM images and EDS mapping images of Comparative Example 1 and Example 4.

In FIG. 12, FIGS. 12(A) and 12(B) are cross-sectional SEM images, and FIGS. 12(C) and 12(D) are AFM-SSRM results, in which FIGS. 12(A) and 12(C) on the left side are results of Comparative Example 1, and FIGS. 12(B) and 12(D) on the right side are results of Example 4. In FIG. 13, FIG. 13(A) shows Comparative Example 1, and FIG. 13(B) shows Example 4. Since bare-wet (96:2:2), which is Comparative Example 1, further included carbon black particles (2 wt %) having a low density, it was confirmed that the electrode density was low at ˜3.6 g/cm³. In addition, it was confirmed that space between particles was present in the positive electrode plate even after the process of preparing the electrode plate by pressing at high pressure.

CNT-dry (99.6:0:0.4), which is Example 4, did not include carbon black and used a positive electrode active material coated with carbon nanotubes, and thus, it was confirmed that there was little space between particles, no micro-cracks, and a high electrode density of ˜4.0 g/cm³.

AFM-SSRM was used to confirm a cross-section of the two electrodes to visualize an electron conduction path. In the SSRM image, it was confirmed that resistance map characteristics between Comparative Example 1 and Example 1 were similar even though the contents 4 the conductive material and the binder were different.

In the SEM-EDS mapping image, it was confirmed that carbon nanotubes (0.2 wt %) were uniformly distributed throughout the positive electrode even though the CNT-dry (99.6:0:0.4) of Example 4 included a small amount of carbon nanotubes. On the other hand, in bare-wet (96:2:2), which is Comparative Example 1, it was confirmed that carbon black particles were locally separated and agglomerated. In addition, it was confirmed that a large number of carbon black was present in an upper region (opposite to the current collector) of the electrode, which can be ascribed to the movement of the carbon black to an upper side of the positive electrode plate during the evaporation of the solvent in the preparation of the positive electrode plate.

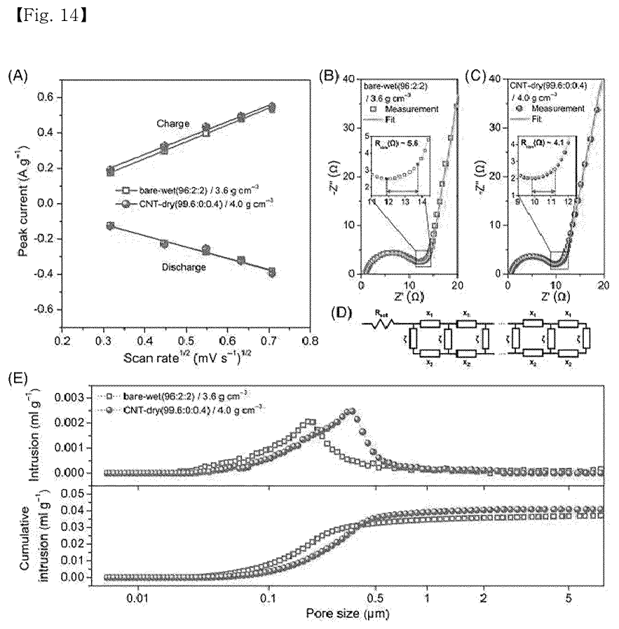

FIG. 14 is a view showing electrochemical characteristics of Comparative Example 1 and Example 4.

In FIG. 14, FIG. 14(A) shows a relationship between peak currents, which are square root functions as a function of scan rates of Comparative Example 1 and Example 4. FIGS. 14(B) and 14(C) show Nyquist plots for Comparative Example 1 and Example 4, respectively. FIG. 14(D) shows equivalent circuit modeling, and FIG. 14(E) shows pore size distributions of Comparative Example 1 and Example 4.

Referring to FIG. 14, lithium ion migration performance was confirmed by performing CV, EIS, and mercury intrusion methods in the positive electrode plates according to Comparative Example 1 and Example 4. In a Randles-Sevcik equation (ip∝A·D_{Li+}^{0.5}·ν^{0.5}), a peak current (iₚ) is determined according to a surface area (A) of a redox active material, a Li⁺ diffusion coefficient (D_{Li+}^{0.5}), and a scan rate (ν) when measuring the CV, and as a result, a gradient (iₚ/ν^{0.5}) represents Li⁺ diffusion characteristic of the electrode. Referring to FIG. 14(A), it can be confirmed that the gradients of Comparative Example 1 and Example 4 are similar. In Comparative Example 1, carbon black particles having a high surface area increase a twisted shape of a transport path of Li ions through the liquid electrolyte in the positive electrode plate, and thus the diffusion of Li ions is reduced.

On the other hand, it is considered that Example 4 has high electrical conductivity even though Example 4 does not contain carbon black, and diffusion of Li ions is not deteriorated even when the positive electrode active material is coated with carbon nanotubes (see Nyquist plot).

FIG. 14(E) shows pore size distributions on upper sides of Comparative Example 1 and Example 4, respectively. Based on a loading level per unit area (22 mg/cm²), a pore volume of Comparative Example 1 was 0.037 ml/g and a pore volume of Example 4 was 0.04 ml/g. Example 4 was 4.0 g/cm³, which had a higher apparent density than Comparative Example 1 (3.6 g/cm³), but the pore volume on the surface of the positive electrode plate was higher than that of Comparative Example 1. This means that the method as in Example 4 may improve the energy density as much as possible together with the efficient transport ability of Li ions.

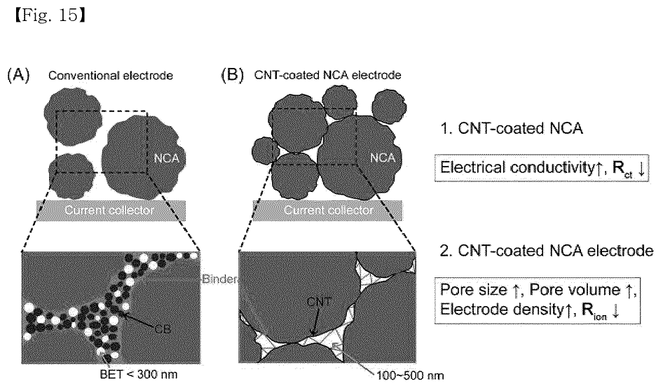

FIG. 15 is a schematic view showing an effect of the positive electrode according to the present invention.

Referring to FIG. 15, during preparation of the positive electrode plate by a wet method as in bare-wet (96:2:2), a particle-shaped carbon black (conductive material) and PVdF (binder) are provided between particles of the positive electrode active material. The conductive material provided between the positive electrode active material particles may have little effect on electronic conductivity, and only the surface of the positive electrode active material and the conductive material provided adjacent thereto may directly affect the electronic conductivity. That means that there are many cases in which carbon black included in the positive electrode does not make direct contact with the positive electrode active material, and a large amount of conductive material is required to improve the electronic conductivity of the positive electrode active material by the carbon black.

On the other hand, as in the present embodiment, when the carbon nanotubes are coated on the surface of the positive electrode active material, the electron conductivity is sufficiently improved by the carbon nanotubes and resistance to charge transfer is low, so that the conductive material may be omitted. Accordingly, since the density of the electrode may increase while increasing the size and volume of pores between the positive electrode active material particles, mobility of lithium ions may be effectively improved.

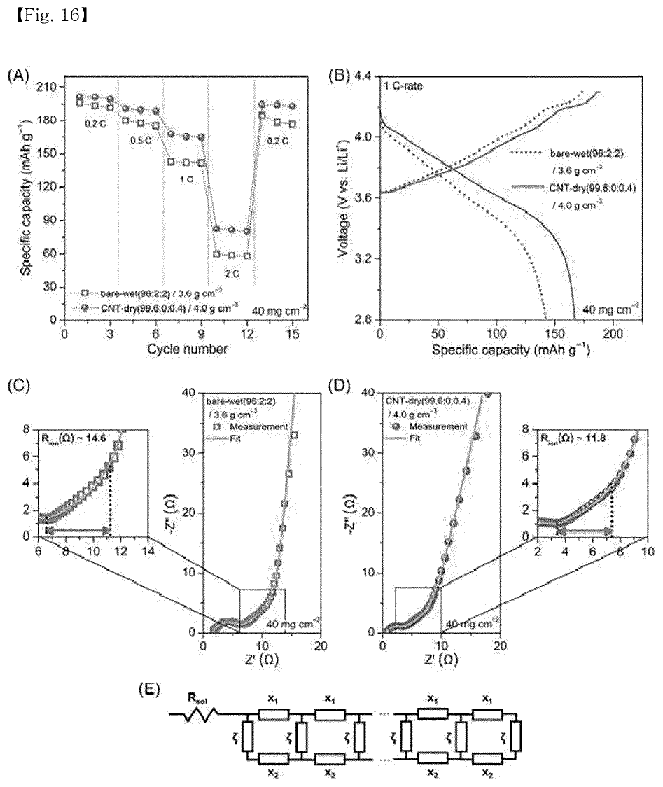

FIG. 16 is a view showing rate-specific characteristics, charge/discharge profiles, and Nyquist plots of Comparative Example 4 and Example 6.

Referring to FIG. 16, Comparative Example 4 and Example 6 are positive electrode plates prepared in the same manner as Comparative Example 1 and Example 4, respectively, and prepared by increasing the loading level to 40 mg/cm². As a result, when the rate-specific characteristics for Comparative Example 4 and Example 6 were confirmed, it was confirmed that the loading levels of Comparative Example 4 and Example 6 increased compared to Comparative Example 1 and Example 4 to increase ohmic resistance, and accordingly, the discharge rate was lowered. It was confirmed that Example 4 exhibited higher rate-specific characteristics even at the loading level of 40 mg/cm² compared to Comparative Example 4. In addition, when the charge/discharge profile at 1 C was confirmed, Example 4 exhibited a higher discharge capacity at 168 mAh/g compared to Comparative Example 1 (143 mAh/g).

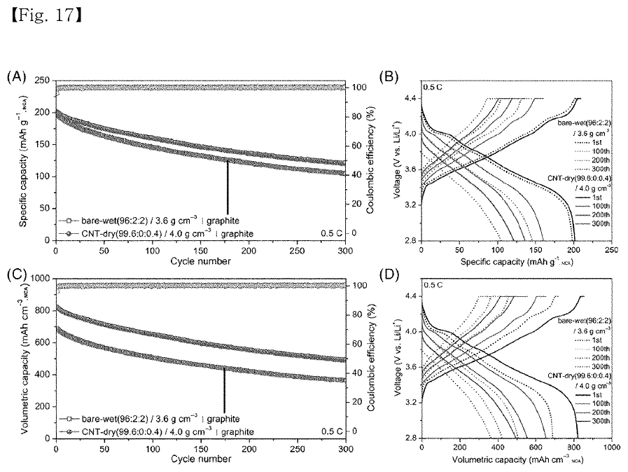

FIG. 17 is a graph showing cycle characteristics of Comparative Example 1 and Example 6.

Referring to FIG. 17, the cycle characteristics were evaluated in a range of 2.8 V to 4.4 V (1 C=4.6 mA/cm²) at 0.5 C, and it was confirmed that the positive electrode plate of Example 6, which was prepared by a dry method, exhibited better specific capacity and cycle characteristics compared to the positive electrode plate prepared by a wet method. In addition, it was confirmed that at 300 cycles, Example 6 had a capacity retention of 60%, which was higher than the capacity retention of Comparative Example 1 of 52%.

Those skilled in the art to which the present invention pertains will understand that the present invention may be implemented in other specific forms without changing the technical spirit or essential features thereof. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

### DESCRIPTION OF REFERENCE NUMERALS

10: Positive electrode active material
11: Lithium transition metal oxide
12: Surface layer
100: Positive electrode for lithium secondary battery
110: Positive electrode mixture raw material
120: Rolling roll
130: Sheet-shaped preliminary positive electrode layer
140: Current collector
150: Heating roll
160: Sheet-shaped positive electrode layer

1. A positive electrode active material for a lithium secondary battery, the positive electrode active material comprising:
a particle-shaped lithium transition metal oxide; and
a surface layer provided with a thickness of 10 nm to 100 nm on a surface of the lithium transition metal oxide,
wherein the surface layer includes carbon nanotubes having a three-dimensional reticular form and an organic compound physically attached to the carbon nanotubes,
the carbon nanotubes are connected in a reticular form on the surface of the lithium transition metal oxide to form a mutual electrical network, and at least a portion of the carbon nanotubes are spaced apart to provide a space in a thickness direction of the surface layer, and
the organic compound is included in an amount of 30 parts by weight to 90 parts by weight based on 100 parts by weight of the carbon nanotubes.

2. The positive electrode active material of claim 1, wherein the carbon nanotubes are formed in a bundle form by partially concentrating 1 to 10 single-walled carbon nanotubes or multi-walled carbon nanotubes, and the bundle form has a diameter of 2 nm to 35 nm and a length of 10 μm to 10 mm, and
as components of the carbon nanotubes, a content of oxygen atoms with respect to carbon atoms is 0.01 mol % to 10 mol %.

3. The positive electrode active material of claim 1, wherein a ratio (ID/IG) of a maximum peak intensity of a D band at 1340 nm to 1360 nm with respect to a maximum peak intensity of a G band at 1575 nm to 1600 nm, which is obtained by a Raman spectrum using a laser having a wavelength of 514.5 nm, is 0.5 to 1.5.

4. The positive electrode active material of claim 1, wherein a ratio of a surface area (S1) of the lithium transition metal oxide with respect to a surface area (S2) of the positive electrode active material satisfies Expression 1 below:
$$0.02 \leq S 1 / S 2. \qquad ( Expression 1 )$$

5. The positive electrode active material of claim 1, wherein the organic compound includes any one or more functional groups of an epoxy group, a carboxyl group, an amino group, an ether group, an amine group, an imide group, a nitrile group, an acrylic group, a double bond, and a triple bond.

6. The positive electrode active material of claim 1, wherein the lithium transition metal oxide includes secondary particles composed of a group of a plurality of primary particles,
the secondary particles are represented by Chemical Formula 1 below, and
the secondary particles have an average particle diameter (D50) of 2 μm to 30 μm and a BET specific surface area of 0.1 m²/g to 1.0 m²/g:
LiₐNi_{1-x-y}CoₓM1_{y}O₂ [Chemical Formula 1]
(wherein M1 is any one or at least two elements selected from the group consisting of Mn, Al, Zr, Ti, Mg, Ta, Nb, W, Mo, and Cr, and satisfies 1.0≤a≤1.5, 0≤x≤0.5, 0≤y≤0.5, and 0≤x+y≤0.5).

7. The positive electrode active material of claim 1, wherein the lithium transition metal oxide includes single particles and a plurality of fine particles attached to a surface of the single particles,
the single particles are represented by Chemical Formula 1 below,
the single particles have an average particle diameter (D50) of 2 μm to 10 μm and a BET specific surface area of 0.5 m²/g to 2.5 m²/g, and
the fine particles have an average particle diameter (D50) of 0.01 to 0.1 times the average particle diameter of the single particles:
LiₐNi_{1-x-y}CoₓM1_{y}O₂ [Chemical Formula 1]
(wherein M1 is any one or at least two elements selected from the group consisting of Mn, Al, Zr, Ti, Mg, Ta, Nb, W, Mo, and Cr, and satisfies 1.0≤a≤1.5, 0≤x≤0.5, 0≤y≤0.5, and 0≤x+y≤0.5).

8. The positive electrode active material of claim 1, wherein the positive electrode active material has a powder conductivity of 0.01 S/cm to 1 S/cm under a pressure of 4 kN/cm².

9. The positive electrode active material of claim 1, wherein the lithium transition metal oxide includes 50 mol % or greater of nickel (Ni),
a content ratio of the carbon nanotubes with respect to the lithium transition metal oxide is 0.1 wt % to 1 wt %, and
the carbon nanotubes are in an amount of 30 parts by weight to 80 parts by weight based on total 100 parts by weight of the carbon nanotubes and the organic compound.

10. The positive electrode active material of claim 1, wherein the surface layer is provided by impregnating the lithium transition metal oxide in a CNT ink and physically applying a force thereto,
the CNT ink includes an organic solvent, the carbon nanotubes, and the organic compound,
the organic solvent includes any one or more of N-methyl-2-pyrrolidone (NMP), polypyrrolidone, isopropanol, petroleum ether, tetrahydrofuran, ethyl acetate, N,N-dimethylacetamide, N,N-dimethylformamide, n-hexane, and halogenated hydrocarbon, and
the organic compound includes any one or more of polyacrylonitrile (PAN), polyvinyl pyrrolidone (PVP), polyvinyl alcohol (PVA), polyacrylic acid (PAA), and polyamideimide (PAI).

11. A method for preparing a positive electrode active material for a lithium secondary battery, the method comprising:
preparing a CNT ink by adding a carbon nanotube raw material and an organic compound to an organic solvent;
preparing a dispersion solution by adding a lithium transition metal oxide to the CNT ink;
adding an additive and an anti-solvent to the dispersion solution; and
drying a mixture thereof in an oven at a temperature of 120° C. to 180° C. for 1 hour to 24 hours.

12. The method of claim 11, wherein the organic solvent includes any one or more of N-methyl-2-pyrrolidone (NMP), polypyrrolidone, isopropanol, petroleum ether, tetrahydrofuran, ethyl acetate, N,N-dimethylacetamide, N,N-dimethylformamide, n-hexane, and halogenated hydrocarbon,
the organic compound includes any one or more of polyacrylonitrile (PAN), polyvinyl pyrrolidone (PVP), polyvinyl alcohol (PVA), polyacrylic acid (PAA), and polyamideimide (PAI),
the anti-solvent includes any one or more of ultrapure water, methanol, acetone, and ethanol, and
the additive includes any one or more of a chloride, a carbonate, a hydroxide, and a nitrate of metal.

13. The method of claim 11, wherein the preparing of the CNT ink includes ultrasonically mixing for 0.5 hours to 12 hours,
the preparing of the dispersion solution includes physically stirring for 0.5 hours to 72 hours,
the adding of the additive and the anti-solvent includes physically stirring for 5 minutes to 1 hour at 100 rpm to 5000 rpm after adding the additive and the anti-solvent, and
the drying further includes selecting a solid-phase material before putting the same in the oven.

14. A positive electrode for a lithium secondary battery, the positive electrode comprising: the positive electrode active material of any one of claim 1; a binder; and a conductive material,
wherein based on total 100 parts by weight of the positive electrode active material, the binder, and the conductive material, the binder is included in an amount of 0.2 parts by weight to 3 parts by weight and the conductive material is included in an amount of 0 parts by weight to 5 parts by weight.

15. The positive electrode of claim 14, wherein the conductive material includes any one or more of carbon nanotubes, graphene, graphite, carbon black, and carbon fiber, and
the binder includes any one or more of polyvinylidene fluoride (PVDF), polytetrafluoroethylene (PTFE), polyacrylic acid (PAA), and polyamideimide (PAI).

16. A method for preparing a positive electrode for a lithium secondary battery, the method comprising:
preparing a positive electrode mixture raw material by physically mixing the positive electrode active material of any one of claim 1 and a powdered binder at room temperature;
preparing the positive electrode mixture raw material into a sheet-shaped preliminary positive electrode layer using a rolling roll; and
preparing the positive electrode by attaching the sheet-shaped preliminary positive electrode layer to at least one surface of a current collector and pressing the sheet-shaped preliminary positive electrode layer using a heating roll at a temperature of 20° C. to 350° C.,
wherein the positive electrode is provided by laminating one or more sheet-shaped positive electrode layers and one or more current collectors, and
the sheet-shaped positive electrode layer has a loading level of 10 mg/cm² to 50 mg/cm².

17. The method of claim 16, wherein the preparing of the positive electrode mixture raw material includes stirring and mixing the positive electrode active material and the powdered binder at room temperature, and
in the preparing of the sheet-shaped preliminary positive electrode layer, the binder included in the sheet-shaped preliminary positive electrode layer is dispersed in a fibril form having a fibrous structure.

18. The method of claim 16, wherein, in the preparing of the sheet-shaped preliminary positive electrode layer, the rolling roll applies a pressure of 5 kgf/cm to 100 kgf/cm at a temperature of 20° C. to 350° C., and
in the preparing of the positive electrode, the heating roll applies a pressure of 5 kgf/cm to 100 kgf/cm at a temperature of 20° C. to 350° C.

19. The method of claim 16, wherein the powdered binder includes any one or more of polyvinylidene fluoride (PVDF), polytetrafluoroethylene (PTFE), polyacrylic acid (PAA), and polyamideimide (PAI), and
the powdered binder is included in an amount of 0.4 parts by weight to 5 parts by weight based on 100 parts by weight of the positive electrode active material.

20. The method of claim 16, wherein the positive electrode active material has an average particle diameter (D50) of 2 μm to 30 μm, and the powdered binder has an average particle diameter (D50) of 2 μm to 800 μm, or
wherein the sheet-shaped preliminary positive electrode layer has a thickness of 50 μm to 500 μm, the sheet-shaped positive electrode layer has a thickness of 30 μm to 200 μm, and a density of the sheet-shaped preliminary positive electrode layer may be 30% to 90% with respect to a density of the sheet-shaped positive electrode layer, and an electrical conductivity of the sheet-shaped positive electrode layer is 0.1 S/cm or greater, or
wherein the current collector has a thickness of 3 μm to 500 μm and a tensile strength of 135 to 265 N/mm², and the current collector includes any one or more of aluminum, stainless steel, nickel, titanium, and calcined carbon.
